(19) United States
(12) Patent Application Publication
(10) Pub. No.: US 2009/0032776 A1
(43) Pub. Date: Feb. 5, 2009

(54) ELECTROLUMINESCENT MATERIALS AND THEIR USE

(75) Inventors: Junyou Pan, Frankfurt (DE); Rene Scheurich, Gross- Zimmern (DE)

Correspondence Address: CONNOLLY BOVE LODGE & HUTZ, LLP, P O BOX 2207, WILMINGTON, DE, 19899, US

(73) Assignee: Merck Patent GmbH, Damstadt (DE)

(21) Appl. No.: 12/162,219

(22) PCT Filed: Jan. 18, 2007
(86) PCT No.: PCT/EP07/00429

§ 371 Date: Oct. 3, 2008

(30) Foreign Application Priority Data
Jan. 26, 2006 (DE) 102006003710.3

(51) Int. Cl. H01B 1/12; C08G 63/08; C08L 67/04

(52) U.S. Cl. 252/500; 528/190; 525/390

(57) ABSTRACT

The invention relates to polymers containing at least 0.5 mol % of units of formula (3)

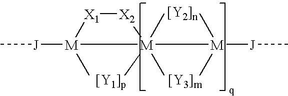

wherein J, M, X₁, X₂, Y₁ₚ, Y₂ₙ, Y₃ₘ and _{q} are as defined in the specification.

The present invention relates to electroluminescent materials, i.e.: monomers, polymers, blends and formulations comprising these polymers, and to the use of the monomers, polymers, blends and formulations according to the invention in electronic and optoelectronic components.

Broadly based research into the commercialisation of display and illumination elements based on organic and polymeric light-emitting diodes (OLEDs/PLEDs) has been under way for more than 10 years. This development was triggered by the basic developments disclosed in WO 90/13148. However, significant improvements in the materials used are still necessary in order to make these displays a true competitor to the liquid-crystal displays (LCDs) which currently dominate the market.

In the case of polymers, it is necessary, for the production of all three emission colours, to copolymerise certain comonomers into the corresponding polymers (cf., for example, WO 00/46321, WO 03/020790 and WO 02/077060). In this way, it is then generally possible, starting from a blue-emitting base polymer (“backbone”), to produce the two other primary colours red and green.

Polymers which have already been proposed or developed for full-colour display elements are various classes of material. Thus, polyfluorene derivatives and polyspirobifluorene, polydihydrophenanthrene and poly-indenofluorene derivatives are suitable. Polymers which contain a combination of two or more of these structural elements have also already been proposed. In addition, polymers which contain poly-para-phenylene (PPP) as structural element are being employed.

The polymers in accordance with the prior art in some cases already exhibit good properties on use in PLEDs. In spite of the advances that have already been achieved, however, these polymers do not meet the demands made of them for high-quality applications.

In particular, the lifetime of the green- and especially of the blue-emitting polymers is still inadequate for many applications. The same applies to the efficiency of the red-emitting polymers. Furthermore, the emission colour is still not sufficiently dark blue in the case of many blue-emitting polymers in accordance with the prior art.

Most of the polymer backbones used today, such as, for example, fluorenes, spirobifluorenes, indenofluorenes, etc., have very high LUMO orbitals, for example at −2.5 eV. One consequence of this is that metals having a low work function, such as, for example, barium, calcium or caesium, have to be used as cathode material for injection of electrons into the polymer. These reactive cathode metals have the disadvantage of being extremely sensitive to oxygen and moisture. Excellent encapsulation is therefore a vital prerequisite for long-lived devices. For these reasons, a polymer system having a low LUMO is particularly preferred for use in polymeric organic displays (PLEDs), since it makes a broader spectrum of cathode materials accessible. It very particularly allows the use of aluminium, which is more resistant to environmental influences than the above-mentioned materials, as the sole cathode material. In addition, a low LUMO is a basic prerequisite for stable and fast electron transport. Fast electron transport is essential for use of materials of this type in applications which, apart from PLEDs, are of major interest:
1. OFETs (organic field-effect transistors): most stable OFETs today are based on a fast p channel. It is of major interest to have OFETs having a stable e channel available, since this allows a drastic simplification of the architecture of the driving current circuit, as desired for use, for example, in active-matrix OLED displays. From further technical points of view, a bipolar stable OFET is a basic prerequisite for light-emitting transistors. These are superior to OLEDs inasmuch as they have the requisite switching elements on board (C. Rost, D. J. Gundlach, S. Karg, and W. Rieβ, Journal of Applied Physics 2004, 95, 5782).
2. For use in photoreceptors in xerography, it is a major advantage to have a stable fast electron conductor available. An electron conductor of this type allows the material to be provided with a positive charge excess, which prevents the otherwise unavoidable stresses of the materials having a negative charge excess (corona). The novel stable electron conductors enable the structure of the devices to be simplified and the lifetime to be significantly increased (K.-L. Law, Chemical Reviews, 1993, 93, 449).
3. For use in organic refractive devices, it is essential to have a stable electron conductor available in order to be able to achieve short response times and effective separation of complementary charges (O. Ostroverkhova and W. E. Moerner, Chemical Reviews 2005, 104, 3267).
4. Not least, stable fast electron conductors are the basic components of organic solar cells.

Surprisingly, it has now been found that a novel class of materials, in particular polymers, has very good properties which are superior to the above-mentioned prior art. The present invention therefore relates to these materials, in particular polymers, and to the use thereof, in particular in PLEDs. The novel structural units are particularly suitable as polymer backbone, but also, depending on the substitution pattern, as hole conductor, electron conductor or emitter. In particular on careful choice of the structural units, a stable electron conductor having a low LUMO can be achieved.

Polymers which contain structural elements of the formula (1) or (2) are known as materials for use in OLED displays. They are described in WO 03/099901 WO 05/033174 and WO 04/039859.

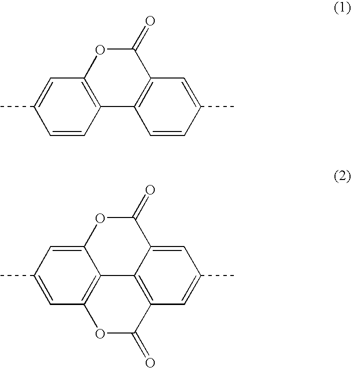

Entirely surprisingly, however, it has been found that structures of the formula (3) have excellent electron-injection and -conduction properties owing to the energetic position of their LUMO orbitals, This also applies, in particular, if structural units of the formula (3) are linked in the manner of ladder polymers.

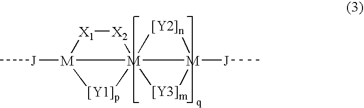

The present invention relates to polymers containing at least 0.5 mol %, preferably at least 5 mol %, particularly preferably at least 10 mol % and in particular at least 50 mol %, of units of the formula (3), where the symbols and indices used have the following meanings:
M is on each occurrence, identically or differently, an aromatic, heteroaromatic or non-aromatic ring system having 2 to 40 C atoms, which may be unsubstituted or substituted by one or more radicals R¹, which may be identical or different on each occurrence,
X₁, X₂ is on each occurrence, identically or differently, a bridge which, with M, forms a cyclic system, selected from B(R¹), C(R¹)₂, Si(R¹)₂, Ge(R¹)₂, C═O, C═S, C═Se, C═Te, C═NR¹, C═C(R¹)₂, O, S, S═O, SO₂, S(R¹)₂, N(R¹), P(R¹), P(═O)R¹, P(═S)R¹, P═O, P═S, P═Se, P═Te, Se, Te or a combination of two, three or four of these groups, or X₁ and X₂ together are an unsubstituted or substituted double bond —CR¹═CR¹— or triple bond —C≡C—, where R¹ may be identical or different on each occurrence and is as defined below,
Y₁, Y₂, Y₃ is on each occurrence, identically or differently, a bridge which, with M, forms a cyclic system, selected from B(R¹), C(R¹)₂, Si(R¹)₂, Ge(R¹)₂, C═O, C═S, C═Se, C═Te, C═NR¹, C═C(R¹)₂, O, S, S═O, SO₂, S(R¹)₂, N(R¹), P(R¹), P(═O)R¹, P(═S)R¹, P═O, P═S, P═Se, P═Te, Se, Te or a combination of two, three or four of these groups, or two Y₁, Y₂ and/or Y₃ are in each case together an unsubstituted or substituted double bond —CR¹═CR¹— or triple bond —C≡C—, where R¹ may be identical or different on each occurrence and is as defined below,
J forms the link to the polymer and can be on each occurrence, identically or differently, a single bond, an unsubstituted or substituted double bond —CR¹═CR¹— or triple bond —C≡C—, an aromatic, heteroaromatic or non-aromatic cyclic unit which is unsubstituted or substituted by R¹, where R¹ may be identical or different on each occurrence and is as defined below or stands for —N—Ar,
R¹ is on each occurrence, identically or differently, H, F, Cl, Br, I, CN, NO₂, NH₂, Si(CH₃)₃, a straight-chain, branched or cyclic alkyl, alkoxy, thioalkoxy or amino group having 1 to 40 C atoms, each of which may be substituted by one or more radicals R², where one or more non-adjacent CH₂ groups may be replaced by N—R², —O—CO—O—, —CO—O—, —CH═CH—, —R²C═CR²—, —C≡C—, Si(R²)₂, Ge(R²)₂, Sn(R²)₂, C═O, C═S, C═Se, C═NR², —O—, —S— or —CONR²— and where one or more H atoms may be replaced by F, Cl, Br, I, CN or NO₂, or an aromatic or heteroaromatic ring system having 2 to 40 aromatic C atoms, which may be substituted by one or more radicals R², or an aryloxy or heteroaryloxy group having 2 to 40 aromatic C atoms, which may be substituted by one or more radicals R², or a combination of these systems; two or more substituents R¹ here may also form a mono- or polycyclic ring system with one another,
R² is on each occurrence, identically or differently, H, halogen, NO₂, CN, NH₂, N(R³)₂ or an aliphatic, aromatic or heteroaromatic hydrocarbon radical having 1 to 20 C atoms,
R³ is on each occurrence, identically or differently, a straight-chain, branched or cyclic alkyl or alkoxy group having 1 to 10 C atoms, an aromatic or heteroaromatic ring system having 2 to 24 C atoms, which may be substituted; the two substituents R³ here may also form a mono- or polycyclic ring system with one another,
n, m, p is on each occurrence, identically or differently, 0, 1 or 2, with the proviso that at least one n or m must be equal to 1 or 2, but preferably with the proviso that all n, m and p cannot simultaneously be 1 or 2, and
q can adopt integer values from 1 to 10⁶, preferably from 1 to 1000 and particularly preferably from 1 to 100.

Even though this is evident from the description, it should again be explicitly pointed out here that the structural units of the formula (3) may be asymmetrically substituted, i.e. different substituents may be present on a single unit, or the substituents X and Y, if present, may be different or may also only occur on one side. If n, m and/or p adopt the value 0, this means that no bridge is present.

For the purposes of the present invention, an aromatic ring system contains 6 to 40 C atoms in the ring system. For the purposes of the present invention, a heteroaromatic ring system contains 2 to 40 C atoms and at least one heteroatom in the ring system, with the proviso that the sum of the C atoms and heteroatoms is at least 5. The heteroatoms are preferably selected from Si, N, P, O, S and/or Ge, particularly preferably selected from N, P, O and/or S. For the purposes of the present invention, an aromatic or heteroaromatic ring system is intended to be taken to mean a system which does not necessarily contain only aryl or heteroaryl groups, but instead in which a plurality of aryl or heteroaryl groups may also be interrupted by a short non-aromatic unit (less than 10% of the atoms other than H, preferably less than 5% of the atoms other than H), such as, for example, a C, N or O atom, Thus, for example, systems such as 9,9′-spiro-bifluorene, 9,9-diarylfluorene, triarylamine, diaryl ether, etc., are also intended to be taken to mean aromatic ring systems for the purposes of the present invention.

For the purposes of the present invention, a non-aromatic ring system contains 3 to 40, preferably 6 to 40, C atoms in the ring system and includes both saturated and also partially unsaturated ring systems, which may be unsubstituted or mono- or polysubstituted by radicals R¹, which may be identical or different on each occurrence and may also contain one or more heteroatoms, preferably Si, N, P, O, S and/or Ge, particularly preferably N, P, O and/or S. These may be, for example, cyclohexyl-like or piperidine-like systems, but also cyclooctadiene-like ring systems. This term is also intended to be taken to mean fused, non-aromatic ring systems.

For the purposes of the present invention, a C1- to C4-0-alkyl group, in which, in addition, individual H atoms or CH₂ groups may be substituted by the above-mentioned groups, is particularly preferably taken to mean the radicals methyl, ethyl, n-propyl, i-propyl, cyclopropyl, n-butyl, i-butyl, s-butyl, t-butyl, cyclobutyl, 2-methylbutyl, n-pentyl, s-pentyl, cyclopentyl, n-hexyl, cyclohexyl, n-heptyl, cycloheptyl, n-octyl, cyclooctyl, 2-ethylhexyl, trifluoromethyl, pentafluoroethyl, 2,2,2-trifluoroethyl, ethenyl, propenyl, butenyl, pentenyl, cyclopentenyl, hexenyl, cyclohexenyl, heptenyl, cycloheptenyl, octenyl, cyclooctenyl, ethynyl, propynyl, butynyl, pentynyl, hexynyl and octynyl. A C1- to C40-alkoxy group is particularly preferably taken to mean methoxy, ethoxy, n-propoxy, i-propoxy, n-butoxy, i-butoxy, s-butoxy, t-butoxy or 2-methylbutoxy. A C2-C40 aryl or heteroaryl group, which may be monovalent or divalent depending on the use, may also in each case be substituted by the above-mentioned radicals R¹ and may be linked to the aromatic or heteroaromatic ring via any desired positions, is particularly preferably taken to mean groups derived from benzene, naphthalene, anthracene, phenanthrene, pyrene, dihydropyrene, chrysene, perylene, fluoranthene, tetracene, pentacene, benzopyrene, furan, benzofuran, isobenzofuran, dibenzofuran, thiophene, benzothiophene, isobenzothiophene, dibenzothiophene, pyrrole, indole, isoindole, carbazole, pyridine, quinoline, isoquinoline, acridine, phenanthridine, benzo-5,6-quinoline, benzo-6,7-quinoline, benzo-7,8-quinoline, phenothiazine, phenoxazine, pyrazole, indazole, imidazole, benzimidazole, naphthimidazole, phenanthrimidazole, pyridimidazole, pyrazinimidazole, quinoxalinimidazole, oxazole, benzoxazole, naphthoxazole, anthroxazole, phenanthroxazole, isoxazole, 1,2-thiazole, 1,3-thiazole, benzothiazole, pyridazine, benzopyridazine, pyrimidine, benzopyrimidine, quinoxaline, pyrazine, phenazine, naphthyridine, azacarbazole, benzocarboline, phenanthroline, 1,2,3-triazole, 1,2,4-triazole, benzotriazole, 1,2,3-oxadiazole, 1,2,4-oxadiazole, 1,2,5-oxadiazole, 1,3,4-oxadiazole, 1,2,3-thiadiazole, 1,2,4-thiadiazole, 1,2,5-thiadiazole, 1,3,4-thiadiazole, 1,3,5-triazine, 1,2,4-triazine, 1,2,3-triazine, tetrazole, 1,2,4,5-tetrazine, 1,2,3,4-tetrazine, 1,2,3,5-tetrazine, purine, pteridine, indolizine and benzothiadiazole. For the purposes of the present invention, aromatic and heteroaromatic ring systems are, apart from the above-mentioned aryl and heteroaryl groups, taken to mean, in particular, biphenylene, terphenylene, fluorene, spirobifluorene, dihydrophenanthrene, tetrahydropyrene and cis- or trans-indenofluorene.

Preference is given to compounds of the formula (3) in which the groups J form the direct connection, i.e. a single bond, to the next structural unit according to the invention, aromatic or heteroaromatic units which are unsubstituted or substituted by R¹, in which R¹ may be identical or different on each occurrence, and double and/or triple bonds, particularly preferably direct connections, aromatic or heteroaromatic units as described above or double bonds, very particularly preferably direct connections and double bonds.

Preference is furthermore given to compounds of the formula (3) in which the symbols M, identically or differently on each occurrence, stand for an aromatic, heteroaromatic or non-aromatic ring system having 2 to 24 C atoms, which may be unsubstituted or substituted by one or two radicals R¹, particularly preferably for an aryl or heteroaryl group selected from benzene, naphthalene, anthracene, phenanthrene, pyridine, pyrene and thiophene, in particular benzene, each of which may be substituted by one or two radicals R¹.

Preference is furthermore given to compounds of the formula (3) in which the symbol R¹, identically or differently on each occurrence, stands for a straight-chain, branched or cyclic alkyl chain having 2 to 15 C atoms, in which, in addition, one or more non-adjacent C atoms may be replaced by N—R²—O—, —S—, —O—CO—O—, —CO—O—, —CH═CH— or —C≡C— and in which, in addition, one or more H atoms may be replaced by F or CN, or an aromatic or heteroaromatic group having 4 to 20 C atoms, which may also be substituted by one or more non-aromatic radicals R¹, or a combination of a plurality of these systems; the two radicals R¹ here may together also form a further mono- or polycyclic, aromatic or aliphatic ring system.

In a further preferred embodiment of the compounds of the formula (3), q has integer values from 1 to 10, preferably from 1 to 6 and particularly preferably from 1 to 4.

An aspect of the invention relates to conjugated polymers. A further aspect of the invention relates to non-conjugated polymers. Still a further aspect of the invention relates to partially conjugated polymers. Preference is given to conjugated or partially conjugated polymers. A further aspect of the present invention relates to branched polymers, which are intended to be taken to mean both highly branched and also dendrimeric polymer structures.

For the purposes of the present invention, conjugated polymers are polymers which contain in the main chain principally sp²-hybridised carbon atoms, which may also be replaced by corresponding heteroatoms. In the simplest case, this means the alternating presence of double and single bonds in the main chain. Principally means that naturally occurring defects which result in conjugation interruptions do not devalue the term “conjugated polymer”, Furthermore, the term conjugated is likewise used in this application text if, for example, arylamine units and/or certain heterocycles (i.e. conjugation via N, O or S atoms) and/or organometallic complexes (i.e. conjugation via the metal atom) are located in the main chain. By contrast, units such as, for example, simple alkyl bridges, (thio)ether, ester, amide or imide links are clearly defined as non-conjugated segments. A partially conjugated polymer is intended to be taken to mean a polymer in which extended conjugated sections in the main chain are interrupted by non-conjugated sections or which contains extended conjugated sections in the side chains of a polymer which is non-conjugated in the main chain.

Besides units of the formula (3), the polymers according to the invention may also contain further structural elements. These are, inter alia, those disclosed and listed in WO 02/077060 and WO 05/014689. The other structural units may originate, for example, from the following classes:
Group 1: units which enhance the hole-injection and/or -transport properties of the polymers;
Group 2: units which enhance the electron-injection and/or -transport properties of the polymers,
Group 3: units which have combinations of individual units from group 1 and group 2;
Group 4: units which modify the emission characteristics to such an extent that electrophosphorescence is obtained instead of electrofluorescence;
Group 5: units which improve the transfer from the singlet state to the triplet state;
Group 6: units which influence the morphology or also the emission colour of the resultant polymers;
Group 7: units which are typically used as backbone.

Preferred polymers according to the invention are those in which at least one structural element has charge-transport properties, i.e. which contain units from groups 1 and/or 2.

Structural elements from group 1 which have hole-transport properties are, for example, triarylamine, benzidine, tetraaryl-para-phenylenediamine, triarylphosphine, phenothiazine, phenoxazine, dihydrophenazine, thianthrene, dibenzo-p-dioxin, phenoxathiyne, carbazole, azulene, thiophene, pyrrole and furan derivatives and further O-, S-, N- or P-containing heterocycles having a high HOMO (HOMO=highest occupied molecular orbital) in the range from −4.5 to −6.0 eV. These arylamines and heterocycles preferably result in an HOMO in the polymer of greater than −5.8 eV (against vacuum level), particularly preferably greater than −5.5 eV.

Structural elements from group 2 which have electron-transport properties are, for example, pyridine, pyrimidine, pyridazine, pyrazine, oxadiazole, quinoline, quinoxaline, benzothiadiazole and phenazine derivatives, but also triarylboranes and further O-, S-, N- or P-containing heterocycles having a low LUMO (LUMO=lowest unoccupied molecular orbital) in the range from −2.5 to −4.0 eV. These units in the polymer preferably result in an LUMO of less than −2.7 eV (against vacuum level), particularly preferably less than −3.0 eV.

It may be preferred for the polymers according to the invention to contain units from group 3 in which structures which increase the hole mobility and which increase the electron mobility (i.e. units from groups 1 and 2) are bonded directly to one another. Some of these units may serve as emitters and shift the emission colour into the green, yellow or red. Their use is thus suitable, for example, for the production of other emission colours from originally blue-emitting polymers.

Structural units from group 4 are those which, even at room temperature, are able to emit light from the triplet state with high efficiency, i.e. exhibit electrophosphorescence instead of electrofluorescence, which frequently causes an increase in the energy efficiency. Suitable for this purpose are firstly compounds which contain heavy atoms having an atomic number of greater than 36. Particularly suitable compounds are those which contain d or f transition metals which satisfy the above-mentioned condition. Very particular preference is given here to corresponding structural units which contain elements from groups 8 to 10 (Ru, Os, Rh, Ir, Pd, Pt), but also lanthanide complexes (e.g. Eu³⁺). Suitable structural units for the polymers according to the invention here are, for example, various complexes, which are described, for example, in WO 02/068435, WO 02/081488, EP 1239526 and WO 04/026886. Corresponding monomers are described in WO 02/068435 and DE 10350606 A1.

Structural elements from group 5 are those which improve the transition from the singlet state to the triplet state and which, employed in support of the structural elements from group 4, improve the phosphorescence properties of these structural elements. Suitable for this purpose are, in particular, carbazole and bridged carbazole dimer units, as described in WO 04/070772 and WO 04/113468. Also suitable for this purpose are ketones, phosphine oxides, sulfoxides, sulfones, silane derivatives and similar compounds, as described in DE 10349033 A1.

Besides those mentioned above, structural elements from group 6 which influence the morphology or also the emission colour of the polymers are those which have at least one further aromatic or another conjugated structure which does not fall under the above-mentioned groups, i.e. which has only little influence on the charge-carrier mobility, are not organo-metallic complexes or have no influence on the singlet-triplet transition. Structural elements of this type may influence the morphology, but also the emission colour of the resultant polymers. Depending on the unit, they can therefore also be employed as emitters. Preference is given here to aromatic structures having 6 to 40 C atoms or also tolan, stilbene or bisstyrylarylene derivatives, each of which may be substituted by one or more radicals R¹. Particular preference is given here to the incorporation of 1,4-phenylene, 1,4-naphthylene, 1,4- or 9,10-anthrylene, 2,7- or 3,6-phenanthrylene, 1,6-, 2,7- or 4,9-pyrenylene, 3,9- or 3,10-perylenylene, 4,4′-biphenylylene, 4,4″-terphenylylene, 4,4′-bi-1,1′-naphthylyiene, 4,4′-tolanylene, 4,4′-stilbenzylene or 4,4″-bisstyrylarylene derivatives.

Structural elements from group 7 are units which have aromatic structures having 6 to 40 C atoms which are typically used as polymer backbone. These are, for example, 4,5-dihydropyrene derivatives, 4,5,9,10-tetrahydropyrene derivatives, fluorene derivatives, 9,9′-spirobifluorene derivatives, phenanthrene derivatives, 9,10-dihydrophenanthrene derivatives, 5,7-dihydrodibenzooxepine derivatives and cis- and trans-indenofluorene derivatives. However, since the proportion of units of the formula (3) is, in particular, at least 50 mol %, these structural elements are preferably not used here as the principal polymer backbone.

Preference is given to polymers according to the invention which, besides structural units of the formula (3), simultaneously additionally also contain one or more units selected from groups 1 to 7. It may likewise be preferred for more than one structural unit from a group to be present at the same time.

The proportion of units of the formula (3) is preferably at least 5 mol %, particularly preferably at least 10 mol % and in particular at least 50 mol %. This preference applies, in particular, if the units of the formula (3) are the polymer backbone. In the case of other functions, other proportions may be preferred, for example a proportion in the order of 0.5 to 20 mol % in the case of the hole conductor or emitter in an electroluminescent polymer, For other applications, for example for organic transistors, the preferred proportion may again be different, for example up to 100 mol % in the case of hole- or electron-conducting units.

Preference is given to polymers according to the invention which, apart from structural units of the formula (3), also contain at least one structural unit from the groups 1 to 7 mentioned above. At least two structural units are particularly preferably from different classes of those mentioned above. One of these structural units is very particularly preferably selected from the group of the hole-conducting units and the other group is an emitting unit, where these two functions (hole conduction and emission) may also be taken on by the same unit.

Units of the formula (3) are also suitable, in particular, for the synthesis of white-emitting copolymers. These preferably contain a sufficiently small proportion of green- and red-emitting units so that white emission results overall. The way in which white-emitting copolymers can be synthesised is described in detail in DE 10343606.

Units of the formula (3) are very particularly also suitable for the synthesis of phospholuminescent copolymers. In addition to the units of the formula (3) according to the invention, these then also contain units from group 4 and further units from groups 1 to 7. The proportion of units from group 4 is preferably <20%, particularly preferably <10% and in particular <5%.

The polymers according to the invention preferably have 10 to 10,000, particularly preferably 20 to 5000 and in particular 20 to 2000, recurring units.

The requisite solubility of the polymers is ensured, in particular, by the substituents R¹ on the units of the formula (3) and optionally on further units present. If further substituents are present, these also contribute to the solubility.

In order to avoid impairing the morphology of the film, it is preferred not to have any long-chain substituents having more than 12 C atoms in a linear chain, particularly preferably none having more than 10 C atoms and in particular none having more than 8 C atoms.

Non-aromatic C atoms are, as, for example, in the description of R¹ in relation to formula (3), present in corresponding straight-chain, branched or cyclic alkyl or alkoxy chains.

Preference is given to polymers according to the invention containing units of the formula (3) in which
X₁, X₂ is on each occurrence, identically or differently, a bridge which, with M, forms a cyclic system, selected from C═O, C(R¹)₂, C═C(R¹)₂, O, S, S═O, P═O, SO₂, S(R¹)₂, N(R¹), P(R¹), P(═O)R¹ or a combination of two, three or four of these groups, or X₁ and X₂ together are an unsubstituted or substituted double bond —CR¹═CR¹— or triple bond —C≡C—.

Particular preference is given to polymers according to the invention containing units of the formula (3) in which
X₁, X₂ is on each occurrence, identically or differently, a bridge which, with M, forms a cyclic system, selected from C═O, O or a combination of these groups.

Very particular preference is given to polymers according to the invention containing units of the formula (3) in which
X₁, X₂ is on each occurrence a bridge which, with M, forms a cyclic system, where X₁ represents the element 0 and X₂ represents the group C═O.

Preference is furthermore given to polymers according to the invention containing units of the formula (3) in which Y₁, Y₂ and/or Y₃ is on each occurrence, identically or differently, a bridge which, with M, forms a cyclic system, selected from C═O, C(R¹)₂, C═C(R¹)₂, O, S, S═O, P═O, SO₂, S(R¹)₂, N(R¹), P(R¹), P(═O)R¹ or a combination of two, three or four of these groups, or two Y₁, Y₂ and/or Y₃ are in each case together an unsubstituted or substituted double bond —CR¹═CR¹— or triple bond —C≡C—.

Particular preference is given to polymers according to the invention containing units of the formula (3) in which Y₁, Y₂ and/or Y₃ is on each occurrence, identically or differently, a bridge which, with M, forms a cyclic system, selected from C═O, O or a combination of these groups.

Especial preference is given to polymers according to the invention containing units of the formula (3) in which Y₁, Y₂ and/or Y₃ is on each occurrence, identically or differently, a bridge which, with M, forms a cyclic system, and Y₁, Y₂ and/or Y₃ represents the structural unit C═O(O).

In preferred polymers of the formula (3), M represents on each occurrence, identically or differently, an aromatic ring system having 2 to 40 C atoms, which may be unsubstituted or substituted by one or more radicals R¹, which may be identical or different on each occurrence.

In particularly preferred polymers of the formula (3), M represents on each occurrence, identically or differently, an aromatic ring system having 2 to 40 C atoms, which may be unsubstituted or substituted by one or more radicals R¹, which may be identical or different on each occurrence.

Especial preference is given to polymers of the formula (3) according to the invention in which M represents on each occurrence a benzene system, which may be unsubstituted or substituted by one or more radicals R¹, which may be identical or different on each occurrence.

Preferred polymers according to the invention containing units of the formula (3) are characterised in that n, m and p are on each occurrence, identically or differently, 0, 1 or 2, with the proviso that at least one n or m is equal to 2.

Preferred polymers according to the invention are characterised in that they contain units of the formula (3) in which q adopts integer values.

Particularly preferred polymer according to the invention are characterised in that they contain units of the formula (3) in which q adopts integer values ≦10.

Especially preferred polymers according to the invention are characterised in that they contain units of the formula (3) in which q adopts integer values ≦5.

Depending on the substitution pattern, the units of the formula (3) are suitable for various functions in the polymer. Thus, they can preferably be employed as polymer backbone or as emitter. Which compounds are particularly suitable for which function is described, in particular, by the substituents X and Y. The substituents R¹ also have an influence on the electronic properties of the units of the formula (3).

Examples of preferred units of the formula (3) are structures 3.1 to 3.29 below, in which the link in the polymer is in each case indicated by the dashed bonds. These structures may be substituted at all points where a substitution is possible. However, possible substituents are not shown for reasons of clarity.

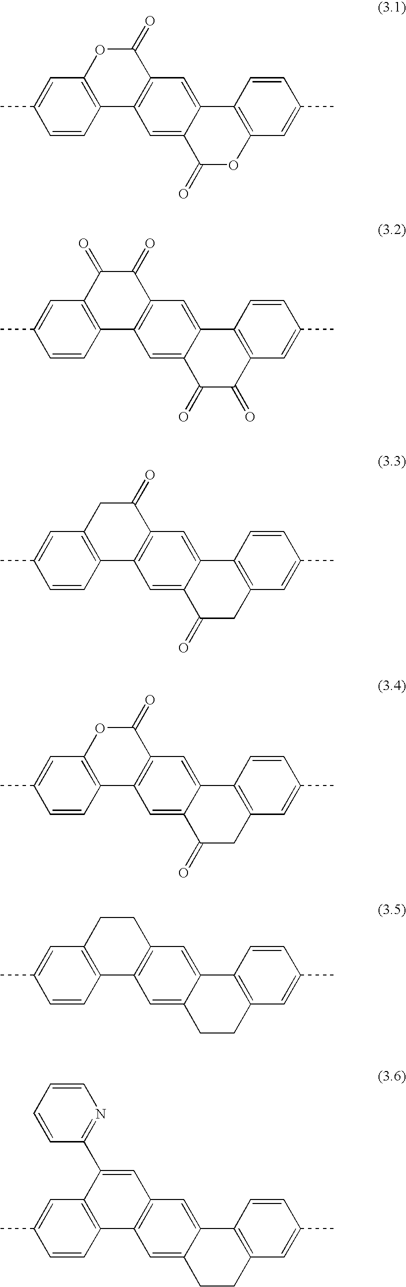

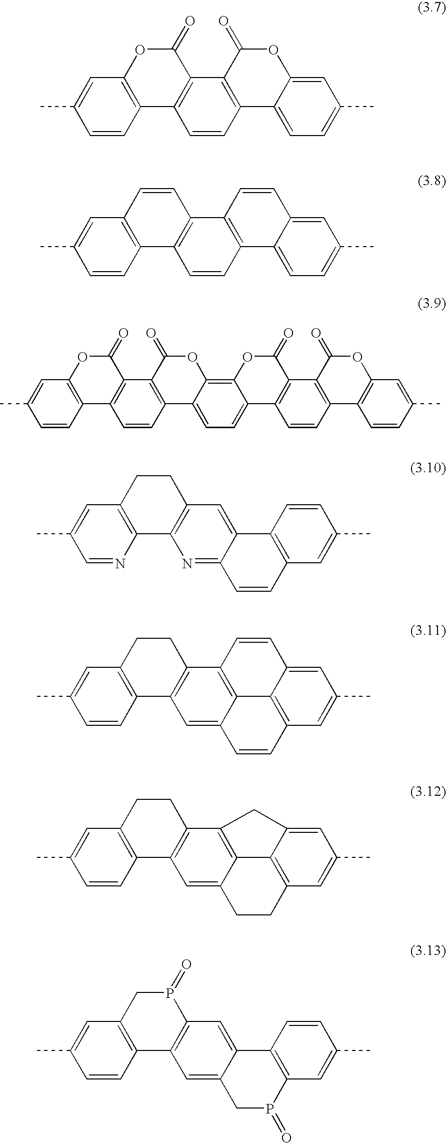

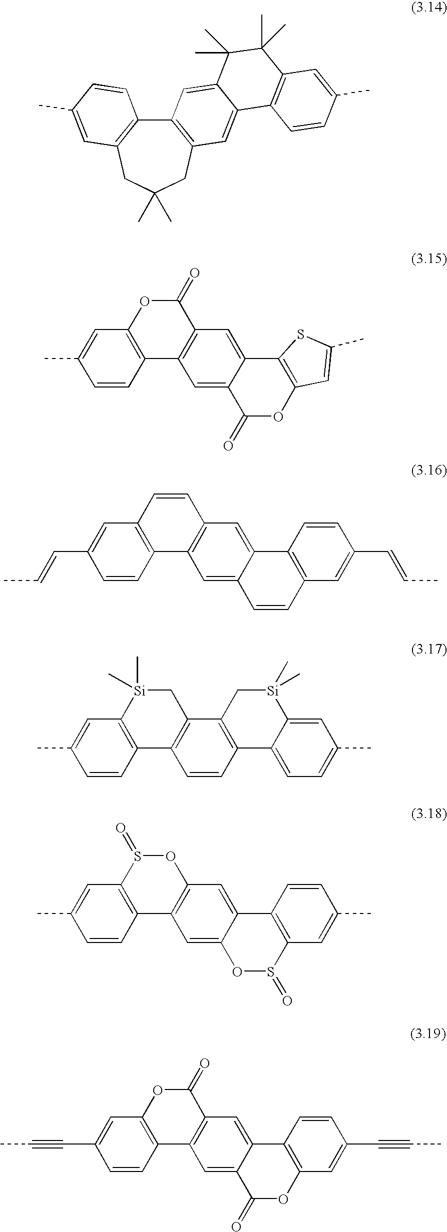

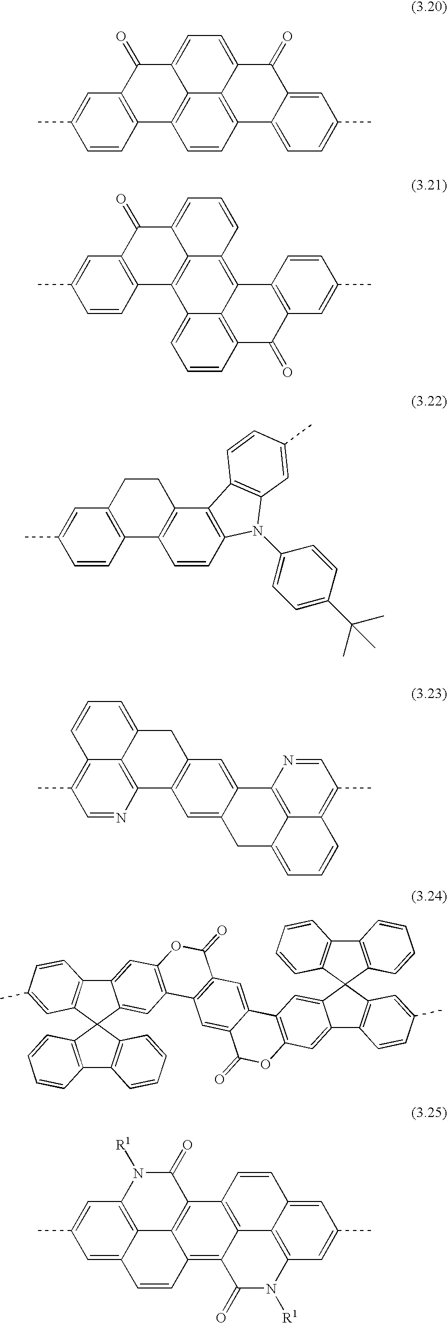

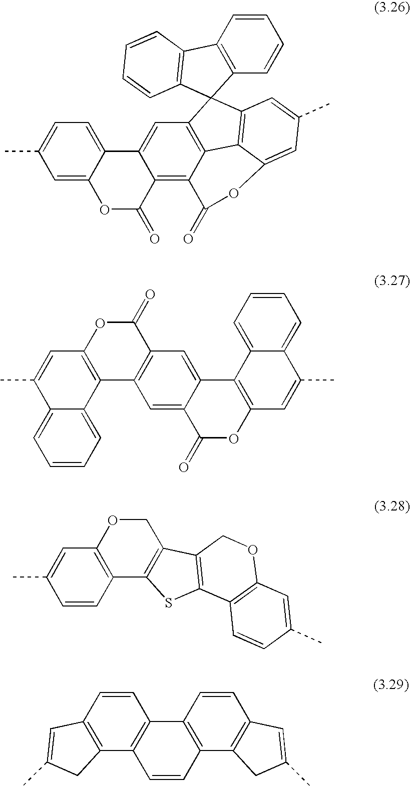

The polymers according to the invention are homopolymers or copolymers. Copolymers according to the invention may potentially, besides one or more structures of the formula (3), have one or more further structures, preferably from groups 1 to 7 mentioned above.

The copolymers according to the invention can have random, alternating or block-like structures or also have a plurality of these structures alternating. The way in which copolymers having block-like structures can be obtained is described in detail, for example, in WO 05/014688. The copolymers may also be highly branched or dendrimeric systems.

The use of a plurality of different structural elements enables properties such as solubility, solid-phase morphology, colour, charge-injection and -transport properties, temperature stability, electro-optical characteristics, etc., to be adjusted.

The polymers according to the invention are prepared by polymerisation of one or more types of monomer, at least one of which results in units of the formula (3) in the polymer. There are in principle many corresponding polymerisation reactions. However, some types which result in C—C or C—N links have proven particularly successful here:

(A) SUZUKI polymerisation;
(B) YAMAMOTO polymerisation;
(C) STILLE polymerisation;
(D) HECK polymerisation;
(E) HIYAMA polymerisation
(F) SONOGASHIRA polymerisation
(G) NEGISHI polymerisation
(H) HARTWIG-BUCHWALD polymerisation.

The way in which the polymerisation can be carried out by these methods and the way in which the polymers can be separated off from the reaction medium and purified is described in detail in WO 04/037887 for reaction types A, B, C and H.

Monomers which result in polymers according to the invention containing structural units of the formula (3) and have suitable functionalities in the 2,7-position (or in a suitable position on Y, if present), which allow this monomer unit to be incorporated into the polymer, are novel and are therefore likewise a subject-matter of the present invention.

This invention furthermore relates to bifunctional monomeric compounds of the formula (4)

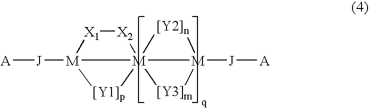

which are characterised in that the two functional groups A, identically or differently, copolymerise under conditions of C—C or C—N linking reactions. The other symbols and indices have the same meaning as in relation to formula (3).

A is preferably selected from CI, Br, I, O-tosylate, O-triflate, O-mesylate, o-nonaflate, SiMe₃₋ₙFₙ (n=1 or 2), O—SO₂R¹, B(OR¹³)₂, —CR¹═C(R¹)₂, —C≡CH and Sn(R¹)₃, particularly preferably from Br, I and B(OR¹)₂, where R¹ has the same meaning as described above, and where two or more radicals R¹ may also form a ring system with one another.

The C—C linking reactions are preferably selected from the groups of the SUZUKI coupling, the YAMAMOTO coupling, the SONOGASHIRA coupling, the HECK coupling and the STILLE coupling. The C—N linking reaction is preferably a HARTWIG-BUCHWALD coupling.

The same preference as described above for the structural units of the formula (3) applies to bifunctional monomeric compounds of the formula (4).

It may be preferred to use the polymer according to the invention not as the pure substance, but instead as a mixture (blend) together with at least one further polymeric, oligomeric, dendritic and/or low-molecular-weight substance of any desired type. These may, for example, improve the electronic properties, influence the transfer from the singlet state to the triplet state or themselves emit light from the singlet or triplet state. However, electronically inert substances may also be appropriate in order, for example, to influence the morphology of the polymer film formed or the viscosity of polymer solutions. The present invention therefore also relates to blends of this type.

The invention furthermore relates to solutions and formulations of at least one polymer according to the invention or a blend according to the invention in at least one solvent. The way in which polymer solutions can be prepared is described, for example, in WO 02/072714, in WO 03/019694 and in the literature cited therein. These solutions can be used to produce thin polymer layers, for example by surface-coating methods (for example spin coating) or printing processes (for example ink-jet printing).

The polymers according to the invention can be used in PLEDs. These comprise a cathode, anode, emission layer and optionally further layers, such as, for example, preferably a hole-injection layer and optionally an interlayer between the hole-injection and emission layers. The way in which PLEDs can be produced is described in detail in WO 04/037887 as a general process, which should be adapted correspondingly for the individual case.

As described above, the polymers according to the invention are particularly suitable as electroluminescent materials in the PLEDs or displays produced in this way.

For the purposes of the present invention, electroluminescent materials are regarded as being materials which can be used as the active layer in a PLED. Active layer means that the layer is capable of emitting light on application of an electric field (light-emitting layer) and/or that it improves the injection and/or transport of the positive and/or negative charges (charge-injection or charge-transport layer). It may also be an interlayer between a hole-injection layer and an emission layer.

The invention therefore also relates to the use of a polymer according to the invention in a PLED, in particular as electroluminescent material.

The invention thus likewise relates to a PLED having one or more active layers, where at least one of these active layers comprises one or more polymers according to the invention. The active layer can be, for example, a light-emitting layer and/or a transport layer and/or a charge-injection layer and/or an interlayer.

The polymers according to the invention have the following surprising advantages over the polyspirobifluorenes and polyfluorenes described in WO 03/020790 and in WO 02/077060, which are hereby mentioned as closest prior art:
(1) It has been found that the polymers according to the invention (with otherwise identical or similar composition) have higher luminous efficiencies in use. This applies, in particular, to the copolymers which exhibit blue emission. This is of enormous importance since thus either the same brightness can be achieved for lower energy consumption, which is very important, in particular, in mobile applications (displays for mobile telephones, pagers, PDAs, etc.) which are reliant on standard and rechargeable batteries. Conversely, greater brightnesses are obtained for the same energy consumption, which may be interesting, for example, for illumination applications.
(2) Furthermore, it has been found, surprisingly, that, again in direct comparison, the polymers according to the invention have longer operating lifetimes, in particular in the case of green- and blue-emitting PLEDs.
(3) The accessibility and achievability of colours is equivalent or better in the case of the polymers according to the invention compared with the prior art. In particular in the case of blue-emitting polymers, an improved colour location and a more saturated blue emission is observed.
(4) The polymers according to the invention are good electron conductors, even without the use of electron-conducting comonomers. Electron-conducting properties in polymers have hitherto only been achievable with difficulty since many electron conductors in accordance with the prior art are not sufficiently stable for high-quality applications.
(5) Since the novel polymer backbone of the formula (3) itself results in dark-blue emission, it is readily possible to introduce emitting units which still result in blue emission in the polymer. It is thus readily possible to separate charge-transport and emission properties in the polymer. This is necessary in order to obtain stable polymers. However, this was only possible with difficulty hitherto since the polymer backbone has itself always simultaneously also emitted.

The present application and the following examples are directed, in particular, to the use of the polymers or blends according to the invention in relation to PLEDs and the corresponding displays. In spite of this restriction to the preferred use of the polymers according to the invention in the description, it is evident to the person skilled in the art without further inventive step that the polymers according to the invention and the blends according to the invention can also be employed for further uses in other organic electronic and organic optoelectronic components (devices), such as, for example, in organic circuits, organic integrated circuits (O-ICs), organic field-effect transistors (O-FETs), organic triodes, organic thin-film transistors (O-TFTs), organic solar cells (O-SCs), organic dye solar cells, organic photovoltaic cells, organic field-quench devices (O-FQDs), organic polymeric light-emitting diodes and also in organic laser diodes (O-lasers), to mention but a few possible applications.

The present invention likewise relates to the use of the polymers according to the invention and the blends according to the invention in the corresponding devices and to these devices themselves.

Furthermore, the comments made can likewise be applied to corresponding oligomers and dendrimers. The present invention likewise relates thereto.

The invention is explained in greater detail by the following examples without wishing it to be restricted thereto.

### EXAMPLES

The quantum-mechanical simulations for Example 1, the corresponding cis-linked structure (Example 2) and the derivatives in which q (in formula (3)) adopts higher values were carried out in order to be able to make comments on the molecular geometry and the position of the energy levels.

The trimeric structures of Examples 5 and 6 were modelled with the aid of the CaChe simulation program (version 6.1). The most energetically stable conformations were found by optimisation using AM1 methods. The calculation of the HOMO and LUMO energy levels was likewise carried out using AM1 methods based on optimised geometries. All five trimers exhibit very low LUMO energy levels, typically at about −3.4 eV. This result, as already explained above, cancels out the strict restriction in the choice of suitable cathode materials.

For simulation of polymer structures of the ladder polymer type based on monomer structural types, such as BB1 (Example 1) or higher homologues BB4 to BB8 thereof (Examples 7 to 11), CaChe 6.1 was used. The geometry optimisation for finding the most energetically favourable conformation, and the calculation of the HOMO and LUMO energy levels of the most energetically favourable conformation was carried out using AM1 methods. The results of these calculations are shown in the examples. It is clearly evident from the calculations that only marginal changes are observed regarding the position of the HOMO and LUMO energy levels in BB8 compared with the prior oligomers and that this can thus be assumed to be an effective conjugation length for a ladder polymer. It is clearly evident from the simulation results that a possible ladder polymer, based on monomer units of the type in Example 1, should have a low LUMO of about −3.72 eV. A specific choice of the monomer composition thus enables very good matching of the LUMO orbital of the ladder polymer to the work function of the cathode material aluminium (−4.08 eV) to be achieved.

### Example 1

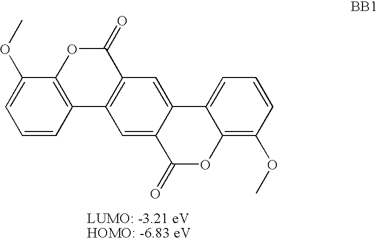

### Example 2

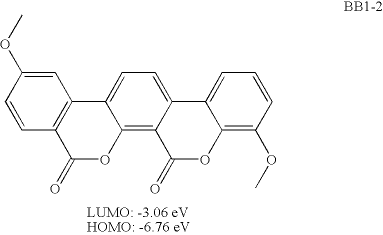

### Example 3

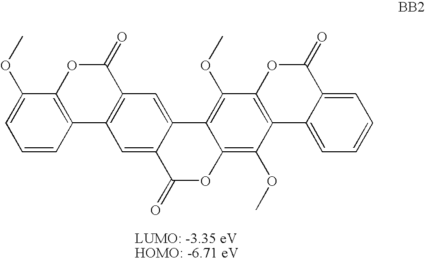

### Example 4

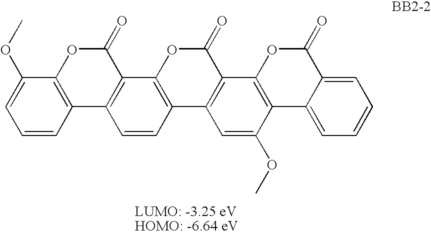

### Example 5

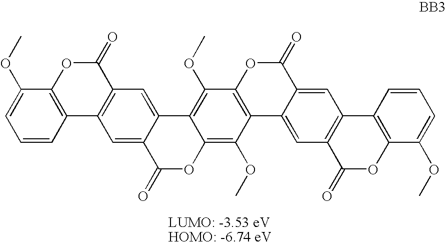

### Example 6

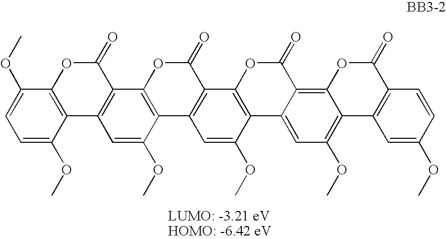

### Example 7

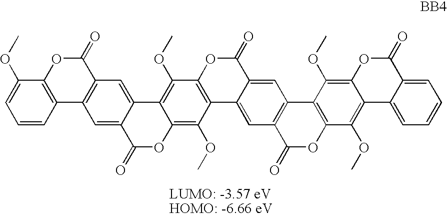

### Example 8

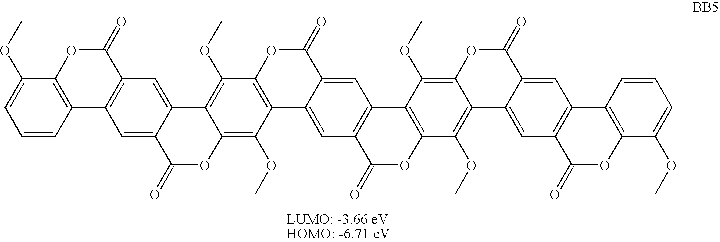

### Example 9

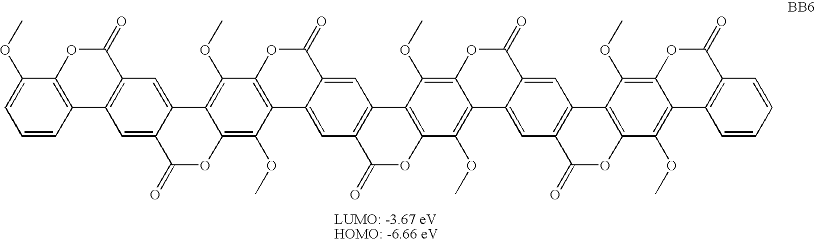

### Example 10

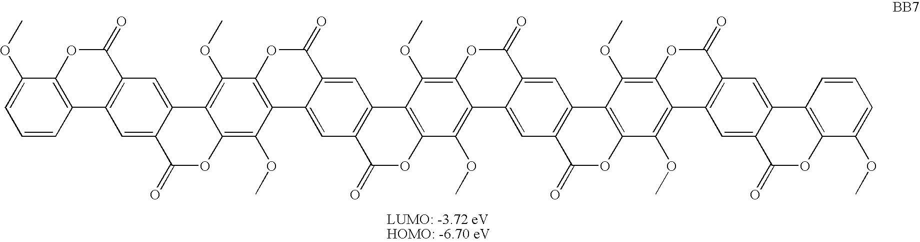

### Example 11

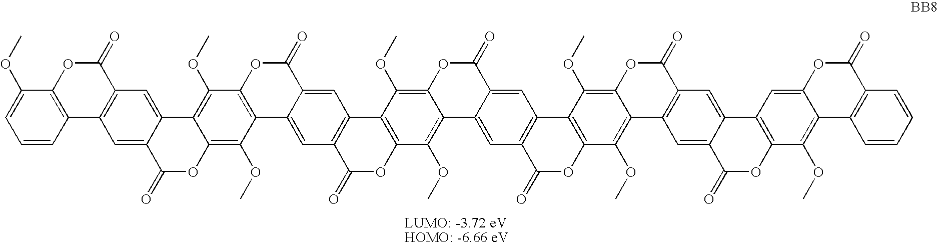

1-21. (canceled)

22. A polymer containing at least 0.5 mol % of units of formula (3) 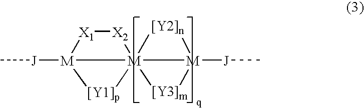
wherein
M is, identically or differently on each occurrence, an aromatic, heteroaromatic, or non-aromatic ring system having 2 to 40 C atoms, optionally substituted, identically or differently on each occurrence, by one or more radicals R¹;
X₁ and X₂
is, identically or differently on each occurrence, a bridge which, with M, forms a cyclic system, and are selected from the group consisting of B(R¹), C(R¹)₂, Si(R¹)₂, Ge(R¹)₂, C═O, C═S, C═Se, C═Te, C═NR¹, C═C(R¹)₂, O, S, S═O, SO₂, S(R¹)₂, N(R¹), P(R¹), P(═O)R¹, P(═S)R¹, P═O, P═S, P═Se, P═Te, Se, Te, or a combination of two, three or four of these groups, or X₁ and X₂ together are an optionally substituted double bond —CR¹═CR¹— or triple bond —C≡C—, wherein R¹ is optionally identical or different on each occurrence;
Y₁, Y₂, and Y₃
is, identically or differently on each occurrence, a bridge which, with M, forms a cyclic system, and are selected from the group consisting of B(R¹), C(R¹)₂, Si(R¹)₂, Ge(R¹)₂, C═O, C═S, C═Se, C═Te, C═NR¹, C═C(R¹)₂, O, S, S═O, SO₂, S(R¹)₂, N(R¹), P(R¹), P(═O)R¹, P(═S)R¹, P═O, P═S, P═Se, P═Te, Se, Te, or a combination of two, three or four of these groups, or two of Y₁, Y₂, and Y₃ are in each case together an optionally substituted double bond —CR¹═CR¹— or triple bond —C═C—, wherein R¹ is optionally identical or different on each occurrence;
J forms the link to the polymer and is, identically or differently on each occurrence, a single bond; an optionally substituted double bond —CR¹═CR¹— or triple bond —C≡C—; an aromatic, heteroaromatic or non-aromatic cyclic unit which is optionally substituted by R¹, wherein R¹ is optionally identical or different on each occurrence and is as defined below or is —N—Ar;
R¹ is, identically or differently on each occurrence, H; F; Cl; Br; I; CN; NO₂; NH₂; Si(CH₃)₃; a straight-chain, branched or cyclic alkyl, alkoxy, thioalkoxy or amino group having up to 40 C atoms optionally substituted by one or more radicals R², wherein one or more non-adjacent CH₂ groups are optionally replaced by N—R², —O—CO—O—, —CO—O—, —CH═CH—, —R²C═CR²—, —C≡C—, Si(R²)₂, Ge(R²)₂, Sn(R²)₂, C═O, C═S, C═Se, C═NR², —O—, —S—, or —CONR²—, and wherein one or more H atoms are optionally replaced by F, Cl, Br, I, CN, or NO₂; an aromatic or heteroaromatic ring system having 2 to 40 aromatic C atoms optionally substituted by one or more radicals R²; or an aryloxy or heteroaryloxy group having 2 to 40 aromatic C atoms optionally substituted by one or more radicals R², or a combination of these systems; and wherein two or more radicals R¹ together optionally define a mono- or polycyclic aliphatic ring system;
R² is, identically or differently on each occurrence, H, halogen, NO₂, CN, NH₂, N(R³)₂, or an aliphatic, aromatic or heteroaromatic hydrocarbon radical having up to 20 C atoms;
R³ is, identically or differently on each occurrence, a straight-chain, branched or cyclic alkyl or alkoxy group having up to 10 C atoms, an optionally substituted aromatic or heteroaromatic ring system having 2 to 24 C atoms; wherein two radicals R³ together optionally define a mono- or polycyclic ring system;
n, m, and p
are, identically or differently on each occurrence, 0, 1, or 2, with the proviso that at least one n or m must be equal to 1 or 2; and
q is an integer value from 1 to 106.

23. The polymer of claim 22, wherein said polymer contains further structural elements which enhance hole-injection and/or -transport properties and which are selected from the group consisting of triarylanine, benzidine, tetraaryl-para-phenylenediamine, triarylphosphine, phenothiazine, phenoxazine, dihydrophenazine, thianthrene, dibenzo-p-dioxin, phenoxathiyne, carbazole, azulene, thiophene, pyrrole, furan derivatives, and O-, S-, N- or P-containing heterocycles having a high HOMO in the range of from −4.5 to −6.0 eV.

24. The polymer of claim 22, wherein said polymer contains further structural elements which enhance electron-injection and/or -transport properties and which are selected from the group consisting of pyridine, pyrimidine, pyridazine, pyrazine, oxadiazole, quinoline, quinoxaline, benzothiadiazole, phenazine, triarylborane derivatives, and O-, S-, N- or P-containing heterocycles having a low LUMO in the range of from −2.5 to −4.0 eV.

25. The polymer of claim 23, wherein said polymer contains both structural elements which enhance hole-injection and/or -transport properties and structural elements which enhance electron-injection and/or -transport properties.

26. The polymer of claim 22, wherein said polymer further contains structural elements which modify the emission characteristics to such an extent that electrophosphorescence is obtained instead of electrofluorescence.

27. The polymer of claim 22, wherein said polymer further contains structural elements which improve the transfer from the singlet state to the triplet state and which are selected from the group consisting of carbazole and bridged carbazole dimer units, ketones, phosphine oxides, sulfoxides, sulfones, and silane derivatives.

28. The polymer of claim 22, wherein said polymer further contains structural elements selected from the group consisting of 1,4-phenylene; 1,4-naphthylene; 1,4-anthrylene; 9,10-anthrylene; 2,7-phenanthrylene; 3,6-phenanthrylene; 1,6-pyrenylene; 2,7-pyrenylene; 4,9-pyrenylene; 3,9-perylenylene; 3,10-perylenylene; 4,4′-biphenylylene; 4,4″-terphenylylene; 4,4′-bi-1,1′-naphthylylene; 4,4′4-tolanylene; 4,4′-stilbenzylene; and 4,4″-bisstyrylarylene derivatives.

29. The polymer of claim 22, wherein said polymer further contains structural elements which are typically used as backbone and are selected from the group consisting of 4,5-dihydropyrene derivatives; 4,5,9,10-tetrahydropyrene derivatives; fluorene derivatives; 9,9′-spirobifluorene derivatives; phenanthrene derivatives; 9,10-dihydrophenanthrene derivatives; 5,7-dihydrodibenzooxepine derivatives; and cis- and trans-indenofluorene derivatives.

30. The polymer of claim 23, wherein said polymer further contains at least two further structural elements which enhance hole-injection and/or -transport properties and which are selected from the group consisting of triarylamine, benzidine, tetraaryl-para-phenylenediamine, triarylphosphine, phenothiazine, phenoxazine, dihydrophenazine, thianthrene, dibenzo-p-dioxin, phenoxathiyne, carbazole, azulene, thiophene, pyrrole, furan derivatives, and O-, S-, N- or P-containing heterocycles having a high HOMO in the range of from −4.5 to −6.0 eV.

31. The polymer of claim 30, wherein one of said further structural units is a hole-conducting unit and the other of said further structural units is an emitting unit.

32. The polymer of claim 22, wherein R¹, identically or differently on each occurrence, is a straight-chain, branched or cyclic alkyl chain having 2 to 15 C atoms, wherein one or more non-adjacent C atoms are optionally replaced by N—R², —O—, —S—, —O—CO—O—, —CO—O—, —CH═CH—, or —C≡—C—, and wherein one or more H atoms are optionally replaced by F or CN; or an aromatic or heteroaromatic group having 4 to 20 C atoms optionally substituted by one or more non-aromatic radicals R¹, or a combination of a plurality of these systems; and wherein two radicals R¹ together optionally define a further mono- or polycyclic, aromatic or aliphatic ring system.

33. The polymer of claim 22, wherein q has an integer value from 1 to 10.

34. The polymer of claim 22, wherein
X₁ and X₂
is, identically or differently on each occurrence, a bridge which, with M, forms a cyclic system, and which are selected from the group consisting of C═O, C(R¹)₂, C═C(R¹)₂, O, S, S═O, SO₂, S(R¹)₂, N(R¹), P(R¹), P(═O)R¹, or a combination of two, three or four of these groups, wherein X₁ and X₂ together are an optionally substituted double bond —CR¹═CR¹— or triple bond —C≡C—.

35. The polymer of claim 22, wherein
Y¹, Y², and Y³
is, identically or differently on each occurrence, a bridge which, with M, forms a cyclic system, and which are selected from the group consisting of C═O, C(R¹)₂, C═C(R¹)₂, O, S, S═O, P═O, SO₂, S(R¹)₂, N(R¹), P(R¹), P(═O)R¹, or a combination of two, three, or four of these groups, where two of Y₁, Y₂, and Y₃ are in each case together an optionally substituted double bond —CR¹═CR¹— or triple bond —C≡C—.

36. The polymer of claim 22, wherein
M is, identically or differently on each occurrence, an aromatic ring system having 2 to 40 C atoms, optionally substituted by one or more radicals R¹, which is optionally identical or different on each occurrence.

37. Bifunctional monomeric compounds of the formula (4) 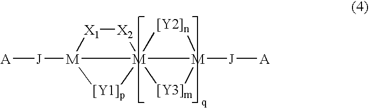
wherein functional groups A, identically or differently on each occurrence, copolymerise under conditions of C—C or C—N linking reactions, and
wherein
M is, identically or differently on each occurrence, an aromatic, heteroaromatic, or non-aromatic ring system having 2 to 40 C atoms, optionally substituted, identically or differently on each occurrence, by one or more radicals R¹;
X₁ and X₂
is, identically or differently on each occurrence, a bridge which, with M, forms a cyclic system, and are selected from the group consisting of B(R¹), C(R¹)₂, Si(R¹)₂, Ge(R¹)₂, C═O, C═S, C═Se, C═Te, C═NR¹, C═C(R¹)₂, O, S, S═O, SO₂, S(R¹)₂, N(R¹), P(R¹), P(═O)R¹, P(═S)R¹, P═O, P═S, P═Se, P═Te, Se, Te, or a combination of two, three or four of these groups, or X₁ and X₂ together are an optionally substituted double bond —CR¹═CR¹— or triple bond —C≡C—, wherein R¹ is optionally identical or different on each occurrence;
Y₁, Y₂, and Y₃
is, identically or differently on each occurrence, a bridge which, with M, forms a cyclic system, and are selected from the group consisting of B(R¹), C(R¹)₂, Si(R¹)₂, Ge(R¹)₂, C═O, C═S, C═Se, C═Te, C═NR¹, C═C(R¹)₂, O, S, S═O, SO₂, S(R¹)₂, N(R¹), P(R¹), P(═O)R¹, P(═S)R¹, P═O, P═S, P═Se, P═Te, Se, Te, or a combination of two, three or four of these groups, or two of Y₁, Y₂, and Y₃ are in each case together an optionally substituted double bond —CR¹═CR¹— or triple bond —C≡C—, wherein R¹ is optionally identical or different on each occurrence;
J forms the link to the polymer and is, identically or differently on each occurrence, a single bond; an optionally substituted double bond —CR¹═CR¹— or triple bond —C≡C—; an aromatic, heteroaromatic or non-aromatic cyclic unit which is optionally substituted by R¹, wherein R¹ is optionally identical or different on each occurrence and is as defined below or is —N—Ar;
n, m, and p
are, identically or differently on each occurrence, 0, 1, or 2, with the proviso that at least one n or m must be equal to 1 or 2; and
q is an integer value from 1 to 10⁶.

38. The bifunctional monomeric compound of claim 37, wherein A is selected from the group consisting of Cl, Br, I, O-tosylate, O-triflate, O-mesylate, O-nonaflate, SiMe₃₋ₙFₙ, wherein n=1 or 2, O—SO₂R¹, B(OR¹)₂, —CR¹═C(R¹)₂, —C≡CH, and Sn(R¹)₃, wherein
R¹ is, identically or differently on each occurrence, H; F; Cl; Br; I; CN; NO₂; NH₂; Si(CH₃)₃; a straight-chain, branched or cyclic alkyl, alkoxy, thioalkoxy or amino group having up to 40 C atoms optionally substituted by one or more radicals R², wherein one or more non-adjacent CH₂ groups are optionally replaced by N—R², —O—CO—O—, —CO—O—, —CH═CH—, —R²C═CR²—, —C═C—, Si(R²)₂, Ge(R¹)₂, Sn(R²)₂, C═O, C═S, C═Se, C═NR², —O—, —S—, or —CONR²—, and wherein one or more H atoms are optionally replaced by F, Cl, Br, I, CN, or NO₂; an aromatic or heteroaromatic ring system having 2 to 40 aromatic C atoms optionally substituted by one or more radicals R²; or an aryloxy or heteroaryloxy group having 2 to 40 aromatic C atoms optionally substituted by one or more radicals R², or a combination of these systems; and wherein two or more radicals R¹ together optionally define a ring system;
R² is, identically or differently on each occurrence, H, halogen, NO₂, CN, NH₂, N(R³)₂, or an aliphatic, aromatic or heteroaromatic hydrocarbon radical having up to 20 C atoms;
R³ is, identically or differently on each occurrence, a straight-chain, branched or cyclic alkyl or alkoxy group having up to 10 C atoms, an optionally substituted aromatic or heteroaromatic ring system having 2 to 24 C atoms; wherein two radicals R³ together optionally define a mono- or polycyclic ring system.

39. A mixture of at least one polymer of claim 22 with at least one further polymeric, oligomeric, dendritic, and/or low-molecular-weight substance.

40. A solution or formulation comprising at least one polymer of claim 22 in at least one solvent.

41. A solution or formulation comprising at least one mixture of claim 39 in at least one solvent.

42. An organic electronic component comprising at least one polymer of claim 22.

43. An organic electronic component comprising at least one mixture of claim 39.

44. An organic optoelectronic component comprising at least one polymer of claim 22.

45. An organic optoelectronic component comprising at least one mixture of claim 39.
